(19) United States
(12) Patent Application Publication
(10) Pub. No.: US 2006/0154221 A1
(43) Pub. Date: Jul. 13, 2006

(54) Symbols-scanning test and symbols-and-tracking dual-task test

(75) Inventors: Richard Darryl Jones, Christchurch (NZ); Anthony Steven Pollock, Amaroo (AU)

Correspondence Address: MCCORMICK, PAULDING & HUBER LLP, CITY PLACE II, 185 ASYLUM STREET, HARTFORD, CT, 06103, US

(73) Assignee: CANTERBURY DISTRICT HEALTH BOARD, Christchurch (NZ)

(21) Appl. No.: 10/519,740

(22) PCT Filed: Jul. 4, 2003
(86) PCT No.: PCT/NZ03/00143

§ 371 Date: Dec. 28, 2004

(30) Foreign Application Priority Data
Jul. 9, 2002 (NZ) 520069

(51) Int. Cl. G09B 19/00

(52) U.S. Cl. 434/258

(57) ABSTRACT

Test for assessing a test subject's sensory-motor abilities consisting of presenting to the test subject a number of symbols (4) on a screen (5) and requiring the test subject to identify one or more preselected characteristics of the symbols; the tests are repeated many times with a varying arrangement of symbols and the results are recorded; in addition, the test may require the test subject to simultaneously carry out a random tracking test in which the test subject is required to steer a controllable second symbol (7) along a varying route (6) using manual controls simultaneously with identifying a preselected characteristic of the first symbols (4).

### TECHNICAL FIELD

The present invention relates to sensory-motor tests for use in assessing a test subject's sensory-motor abilities. The tests the subject of the present invention have been developed particularly for assessing whether the test subject is capable of driving a vehicle on a public road safely, and will therefore be described with especial reference to this application. However, it will be appreciated that the tests also would be suitable for assessing sensory-motor and cognitive function in areas other than driver assessment, such as neurology, rehabilitation, and psychology.

Driving a vehicle safely on a public road requires a surprisingly wide range of different abilities:—the driver must be able to physically control the vehicle (motor abilities), see the correct path to be driven (perceptive abilities) and translate this visual information into the correct vehicle control movements (motor planning). Further, the driver has to be able to perceive and assess possible hazards, and take any necessary precautionary actions, whilst continuing to drive at an acceptable speed.

Clearly, testing a driver in a practical driving test can be extremely hazardous if the driver has impairment of any of the necessary abilities. Thus, it is desirable to use objective off-road tests for preliminary assessment of any prospective driver known or suspected to suffer from any condition which may impair his or her driving ability, e.g. a brain lesion of any type (for example such as is caused by stroke, brain injury, Alzheimer's, deterioration due to old age). The term “off-road tests” means a series of tests in which the driver is presented with various visual stimuli/targets on a computer screen and comments on or responds motor wise to symbols appearing on the screen, by means of a manual control such as a joystick or a steering wheel.

### BACKGROUND ART

There are a number of established tests for testing visual acuity, visual resolution, accurate visual perception (static and dynamic), arm and foot speeds and reaction times, steady movement, and a number of tracking tests to gauge visual/motor abilities, (e.g. Jones et al. “Impairment and recovery of ipsilateral sensory-motor function following unilateral cerebral infarction”, Brain, 1989, 112, 113-132).

Two further tests are described in the following publications:—firstly, a paper entitled “Driving Advisement with the Elemental Driving Simulator (EDS): When less suffices”, (Gianutsos, Behavior Research Methods, Instruments & Computers, 1994, 26, 183-186) discloses a test which involves steering a simulated vehicle moving at a fixed pace along a “road”, with the driver being required to react in a predetermined matter to a face symbol (stationery or flashing) appearing unpredictably on either side of the road. The driver's steering unsteadiness and reaction times are measured.

The driver is not required to scan widely across the screen, since the face symbols appear at fixed positions on the screen and can be adequately perceived in terms of presence and colour without direct fixation.

Secondly, a paper “Visual Processing Impairment and Risk of Motor Vehicle Crash Among Older Adults” (Owsley & others, JAMA. 1998; 279: 1083-1088) discloses a test which incorporates some scanning requirements, to test the driver's visual field area. However, the test is wholly verbal:—the driver is not required to make any motor response. The test is poorly described, but would appear to include only perception of the presence of certain symbols and not of any other characteristics assessment of those symbols.

Thus, none of the known tests assess the ability to maintain consistent accurate motor control whilst simultaneously scanning, accurately perceiving multiple objects, and responding quickly and appropriately over a wide visual field:—these skills are essential for safe driving.

It is therefore an object of the present invention to provide tests which quantitatively assess these skills.

### DISCLOSURE OF INVENTION

The present invention provides a test including the following steps:—
(a) providing a screen which can be viewed by the test subject;
(b) presenting for a predetermined period on said screen a plurality of first symbols randomly and widely scattered over said screen, said first symbols being identical or having one or more differences between them;
(c) requiring the test subject to identify one or more preselected characteristics of said first symbols;
(d) recording the results of the test subject's identification;
(e) repeating steps a-d many times, but with the disposition of said first symbols on said screen being varied randomly for each repetition of step (b).

The present invention also provides a test in which:

in step (b) the screen simultaneously presents a random tracking test in which the test subject is required to steer a controllable second symbol along a varying route using manual controls;

in step (c), the test subject is required to steer said controllable symbol along said varying route whilst simultaneously identifying one or more preselected characteristics of said first symbols; and

in step (d), the result of the test subject's tracking performance is also recorded.

Preferably, the pre-determined period for which the randomly and widely scattered symbols are displayed on the screen is in the range 3-6 seconds.

The randomly and widely scattered symbols may be sub-divided into a plurality of different groups, with the test subject required to identify one or more pre-selected characteristics of one or more of the groups, and/or to identify one or more pre-selected differences between one or more of the groups. The identification preferably is verbal, but could require the use of one or more controls (e.g. hand- or foot-operated switches) instead of, or in addition to, verbal identification.

### BRIEF DESCRIPTION OF THE DRAWINGS

By way of example only, a preferred embodiment of the present invention is described in detail with reference to the accompanying drawings, in which:—

FIG. 1 shows a typical screen picture used for a first test in accordance with the present invention (symbols-scanning test); and

FIG. 2 shows a typical screen picture used for a second test (symbols-and-tracking dual-task test) in accordance with the present invention.

### BEST MODE FOR CARRYING OUT THE INVENTION

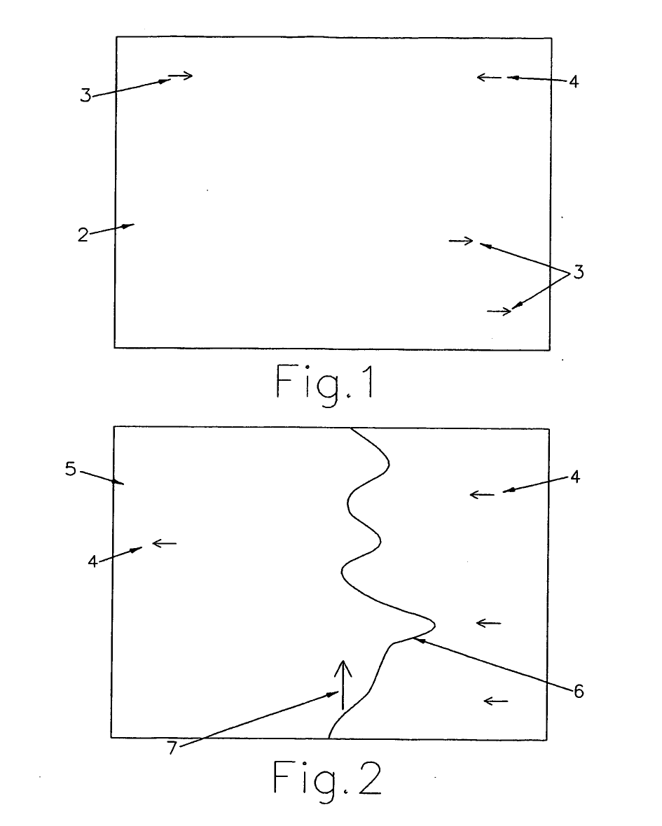

Referring to FIG. 1, the screen 2 for the symbols-scanning test displays four horizontal arrows, three of which (indicated by reference 3) point from left to right, and the fourth of which (indicated by reference 4) points from right to left.

The number of arrows 3,4, may be varied. Also, the characteristics (e.g. orientation) of the arrows may be varied.

In a typical test, the test subject sits in front of the screen and is asked to report verbally to the tester whether all of the arrows point in the same direction or not. Since the arrows are scattered over the screen randomly, the test requires the subject to scan quickly and accurately over all the screen, and to observe and report as soon as possible. Typically, each different set of arrows is displayed for a constant period, (e.g. 3-6 seconds), with a one second interval between each consecutive sets.

The test subject tries to respond verbally as soon as possible with either “same” or “different” to the tester depending upon whether the arrows all point in the same direction or in different directions. The tester keys in the subjects responses as quickly as possible:—“S” or “D” for the “same” or “different”, respectively. To eliminate the delay caused by the tester's own reaction time in recording the responses, the test subject can respond physically e.g., by pressing appropriate hand- or foot-operated switches or levers to record the responses.

Multiple trials are run:—typically, at least 12 different set of arrows are displayed. The test subject's performance is assessed by comparing his or her results with results of the same test from a number of normal control subjects who are known to be competent drivers and not suffering from any impediment or disease.

The symbols-scanning test may be made more difficult by using different groups of symbols and/or by making the subject matter of the test subject report more complex. For example, the symbols could be a mixture of squares, circles and arrows and the test subject could be asked to report only on the direction of the arrows or on whether any arrows overlap with circles, and so on.

FIG. 2 shows the screen 5 used for the dual-task test. In this test, the test subject carries out the symbols-scanning test as described with reference to FIG. 1, and, in addition simultaneously carries out a preview tracking test.

For the tracking test, the test subject is presented with an irregular curve 6 and is asked to use a motor control such as a joystick or steering wheel (not shown) to move a controllable symbol in the form of an arrow 7 horizontally across the screen so that the point of the arrow 7 remains on the curve 6 as the curve moves vertically down the screen. The computer generating the test is programmed to measure the accuracy of the tracking, as described below.

Thus, the test subject tries simultaneously to control the arrow 7 to keep it on the curve 6 (equivalent to steering a vehicle accurately along the road) whilst scanning the whole of the screen (equivalent to a motorist's field of view) to observe the symbols and to report accurately on their orientation. It is considered that the dual-task test gives an objective and reasonable estimate of the level of motor control and visual scanning/perception of the immediate surroundings of the vehicle/observation of the wider area which is required of a competent driver.

The tester keys in the subject's verbal responses to the symbols-scanning component of the dual-task as for the symbols-scanning test on its own. These are recorded and subsequently analyzed by the computer. The subject's performances on both the symbols-scanning and tracking components of the dual-task are compared to the equivalent performances of a group of competent drivers.

For a complete “off-road” test of a driver, first the symbols scanning test described with reference to FIG. 1 would be carried out, using at least 12 trials, i.e. at least 12 repetitions of steps (a)-(d). The responses would be recorded as described above.

Next, the test subject would take a tracking test, i.e. the tracking portion of the test described with reference to FIG. 2. Again, the complete test would consist of a number of repetitions, typically about 12 trials. Finally, the test subject would take the dual task test described with reference to FIG. 2, typically with about 12 trials. Typically, duration of each of the symbols-scanning, tracking, and symbols-and-tracking tests is about 70 seconds.

The tests are analysed as discussed below. In addition to a comparison of the subject's performance with that of an established standard, note also is made of any degradation in performance of the dual test (i.e. the symbols and tracking test) compared to the performance of either the symbols scanning or the tracking tests alone:—persons suffering from impairment of their driving abilities typically can perform the scanning test to a reasonable level and the tracking test to a reasonable level, but are unable to achieve an acceptable level of performance when required to both track and scan.

The test may be made more complex either by increasing the difficulty of the symbols-scanning test as discussed above, and/or by making the tracking test more difficult, for example by speeding up the rate of movement of the curve 6.

Measures of performance on the symbols-scanning test and on the symbols-scanning component of dual-task are typically:

number of correct responses;

number of missed responses,

average delay of responses.

Measure of performance on the tracking test and of the tracking test component of the dual-task are typically:

average absolute error (horizontal distance between target waveform and point of response arrow, sampled at 60 times per second and averaged over duration of test).

average lag between target and response (calculated via cross-correlation of target and response waveforms).

The invention includes the possibility of using different means to record “same” and “different” responses of test subjects on the symbols-scanning and on the symbols-scanning component of the dual-task. Rather than responses being keyed in by the tester, they could be recognized and recorded automatically using voice recognition. Alternatively, a motor rather than verbal response could be required such as pressing foot- or hand-operated switches or levers.

1. A test including the following steps:—
(a) providing a screen which can be viewed by the test subject;
(b) presenting for a predetermined period on said screen a plurality of first symbols randomly and widely scattered over said screen, said first symbols being identical or having one or more differences between them; while simultaneously presenting on said screen a random tracking test in which the test subject is required to steer a controllable second symbol along a varying route using manual controls;
(c) requiring the test subject to identify one or more preselected characteristics of said first symbols; while simultaneously requiring the test subject to steer said controllable symbol along said varying route;
(d) recording the results of the test subject's identification and tracking performance;
(e) repeating steps a-d many times, but with the disposition of said first symbols on said screen being varied randomly for each repetition of step (b).

2. The test as claimed in claim 1, wherein said predetermined period is in the range 3-6 sec.

3. The test as claimed in claim 2 wherein the interval between consecutive tests is approximately 1 sec.

4. The test as claimed in claim 1, wherein said first symbols are divided into two or more groups, with the symbols in one group being different to the symbols in the or each other group, and in step (c), the test subject is required to identify a preselected difference between said groups.

5. The test as claimed in claim 4 wherein said first symbols comprise two groups of horizontal arrows, one group of arrows pointing from right to left, and the other group of arrows pointing from left to right; and in step (c) the test subject is required to identify whether all the arrows appearing on the screen point in the same direction or not.

6. The test as claimed in claim 4 wherein said first symbols are divided into at least three groups.

7. The test as claimed in claim 1 wherein in step (c) the test subject is required to give a verbal identification of said one or more preselected characteristics of said first symbols.

8. The test as claimed in claim 7 wherein said a verbal identification is recorded by a tester.

9. The test as claimed in claim 7 wherein said verbal identification is recorded by a voice recognition computer programme.

10. The test is claimed in claim 1 wherein in step (c) the test subject is required to identify said one or more preselected characteristics of said first symbols by making a preselected motor response.

11. The test as claimed in claim 10 wherein said motor response consists of pressing a switch.

12. (canceled)

13. The test as claimed in claim 1 wherein said manual controls consist of a joystick.

14. The test as claimed in claim 1 wherein said manual controls consists of a steering wheel.

15. The test as claimed in claim 1 wherein said varying route is provided by a curve which moves vertically down the screen.

16. The test as claimed in claim 15 wherein said controllable second symbol consists of an arrow, and in step (c) the test subject is required to steer the arrow so that the point of the arrow remains on the curve.

17. The test as claimed in claim 1 further including the following step:—
(f) assessing the test subject's test results by comparison with standards established by carrying out identical tests on control subjects of known competence.

18. A sequence of tests consisting of three tests, the first test including the following steps:—
(a) providing a screen which can be used by the test subject;
(b) presenting for a predetermined period on said screen a plurality of first symbols randomly and widely scattered over said screen, said first symbols being identical or having one or more differences between them;
(c) requiring the test subject to identify one or more preselected characteristics of said first symbols;
(d) recording the results of the test subject's identification;
(e) repeating steps a-d many times, but with the disposition of said first symbols on said screen being varied randomly for each repetition of step b; said second test including the following steps:—
(a) providing a screen which can be viewed by the test subject;
(b) presenting on said screen a random tracking test in which the test subject is required to steer a controllable second symbol along a varying route using manual controls;
(c) recording the results of the test subject's tracking performance;
(d) repeating steps a-c many times;
the third test comprising a test as claimed in claim 1 or claim 17.
